(19) United States
(12) Patent Application Publication
(10) Pub. No.: US 2012/0110944 A1
(43) Pub. Date: May 10, 2012

(54) FASTENER FOR BUILDING MATERIALS

(76) Inventor: JOSEPH L. HESS, Clearfield, PA (US)

(21) Appl. No.: 13/293,431

(22) Filed: Nov. 10, 2011

Related U.S. Application Data
(60) Provisional application No. 61/412,172, filed on Nov. 10, 2010.

(51) Int. Cl. E04B 1/38; E04B 1/19; B23P 11/00

(52) U.S. Cl. 52/582.1; 29/525.08; 52/650.3

(57) ABSTRACT

A fastener for fastening at least a pair of elongated members to a support structure includes a first arm having a first portion sized to be received within an edge grove or a slot of one elongated member, a second portion disposed substantially perpendicular to the first portion and a third portion disposed at an acute angle to a surface of the support structure prior to use of the fastener, wherein the first portion extends in a first direction from the second portion. There is also a second arm having a portion thereof extending in a second direction being opposite to the first direction, the portion of the second arm is sized to be received within an edge grove or a slot of another elongated member juxtaposed with the one elongated member.

### CROSS-REFERENCE TO RELATED APPLICATIONS

This application is related to and claims priority from U.S. Provisional Patent Application Ser. No. 61/412,172 filed on Nov. 10, 2010.

### FIELD OF THE INVENTION

The present invention relates, in general, to fasteners for building materials and, more particularly, this invention relates to a deck fastener for securing grooved or slotted decking boards or planks to a supporting joist members and yet more particularly, the instant invention relates to deck fastener having a hinged arm.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, fastening clips for attaching elongated deck covering members to joists or elongated covering members to other building structures include some form of spike or tab or similar fixing element that protrudes in opposite directions from an intermediate part fixed to a joist or other supporting structure or substrate, so that the fasteners when placed between two laterally abutting planks engage with the planks and hold both planks to the joist. These include fasteners with flanges that engage in edge slots or grooves of the deck covering members.

However, there is a need for a fastener that improves retention of the covering members on such supporting structure.

### SUMMARY OF THE INVENTION

The invention provides a fastener for fastening at least a pair of elongated members to a support structure. The fastener includes a first arm having a first portion sized to be received within an edge grove or a slot of one elongated member, a second portion disposed substantially perpendicular to the first portion and a third portion disposed at an acute angle to a surface of the support structure prior to use of the fastener, wherein the first portion extends in a first direction from the second portion. The fastener also includes a second arm having a portion thereof extending in a second direction being opposite to the first direction, the portion of the second arm is sized to be received within an edge grove or a slot of another elongated member juxtaposed with the one elongated member. The first and second arms are upstanding on a common base, wherein the first arm is provided in a hinged arrangement with the base.

### OBJECTS OF THE INVENTION

It is, therefore, one of the primary objects of the present invention to provide a fastener for building materials.

Another object of the present invention is to provide a fastener for securing grooved or slotted decking boards or planks to supporting joist members.

Yet another object of the present invention is to provide a deck fastener for securing grooved or slotted decking boards or planks to supporting joist members that has a hinged arm.

A further object of the present invention is to provide a deck fastener for securing grooved or slotted decking boards or planks to supporting joist members that includes prongs or projections for increasing retention of the decking boards or planks.

Another object the present invention is to provide a deck fastener for securing grooved or slotted decking boards or planks to supporting joist members that includes a pair of arms, wherein one arm has a terminal portion thereof positioned at a greater distance from the supporting structure than the terminal portion of the other arm.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a side view of a fastening clip of the invention illustrated in a position prior to being fastened to a supporting structure;

FIG. 2 is a side elevation view of the fastening clip of FIG. 1 illustrated in a position being fastened to the supporting structure;

FIG. 3 is another side elevation view of the fastening clip of FIG. 1, particularly illustrating a pair of arms;

FIG. 4 is a side elevation view of the fastening clip of FIG. 3, particularly illustrating a base portion;

FIG. 5 is a planar top view of the fastening clip of FIG. 4;

FIG. 6 is another side elevation view of the fastening clip of the invention;

FIG. 7 is a planar top view of the fastening clip of FIG. 6;

FIG. 8 is an elevation end view of the fastening clip of FIG. 6;

FIG. 9 is another planar top view of the fastening clip of FIG. 6, particularly illustrating an additional flange;

FIGS. 10-12 illustrate steps of installing the covering members with the fasteners of FIGS. 1-9; and

FIGS. 13-15 illustrate fastening clips of alternative configurations suitable for use in combination with the fasteners of FIGS. 1-2.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

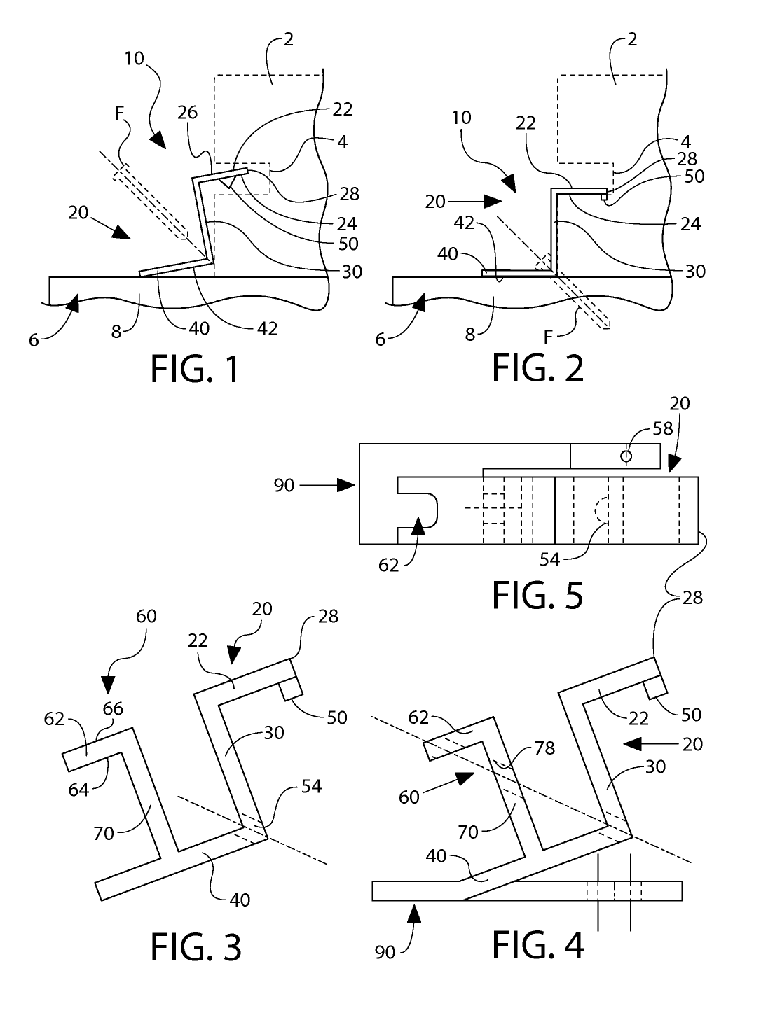

Reference is now made, to FIGS. 1-2, wherein the present invention describes a new style of hidden fastener, generally designated as 10, described and illustrated so as to provide means to install elongated deck covering members, such as boards or planks, 2 with edge slots or grooves 4 to a deck support structure 6 particularly including horizontally disposed joists 8, wherein the elongated deck covering members 2 are positioned on top of joists 8 in a direction perpendicular thereto.

The fastener 10 defines a body or an arm, generally designated as 20, having a first portion 22 sized to be received within an edge groove or a slot of a respective elongated deck covering member 2, a second portion, generally designated as 30, disposed substantially perpendicular to the first portion 22 and a third portion 40 disposed an acute angle thereto prior to use of the fastener 10. All three portions are disposed in series with each other and define overall length of the body or arm 20.

The first portion 22 is disposed at an acute angle to a surface of the support structure 6 prior to use of the fastener 10 and is disposed generally parallel to the support structure 6 when the fastener 10 is fastened to the support structure 6. The surface of the support structure 6 is defined by the upper surface of joists 8. The first portion 22 has a pair of spaced apart planar surfaces 24, 26 defining thickness of the first portion 22 of the body or arm 20. The first portion 22 of the body or arm 20 is so sized that the first portion 22 of the body or arm 20 is received within an edge groove or slot 4 of one elongated structure covering member 2, the first portion 22 of the first arm 20 extends in a first direction.

The second portion 30 of the body or arm 20 is disposed substantially perpendicular to the first portion 22 and extends downwardly therefrom when the fastener 10 is being used.

The third portion 40 is disposed substantially parallel to the first portion 22 and defines a generally Z-shape of the body or arm 20. Thus, the third portion 40 is also disposed at an acute angle to a surface of the support structure 6 prior to use of the fastener 10 and is disposed generally parallel to the support structure 6 when the fastener 10 is fastened to the support structure.

The body or arm 22 is adapted for movement in a generally vertical direction, in reference to FIGS. 1-2, relative to the surface of the support structure. Thus, prior to use of the fastener 10 the third portion 40 is positioned at an angle relative to the surface of the support structure 6 and the first portion 22 is inserted into the edge slot or groove 4. Then the fastener 10 is fastened to the support structure 6 and, more particularly, to the joists 8 by any conventional fasteners F employed in the art. As the fastener 10 is being fastened, the body or arm 20 moves in the generally vertical direction so that when the fastener 10 is fully fastened the third portion 40 is positioned generally horizontally to the surface of the support structure 6 so that a bottom surface 42 of the third portion 40 is disposed in substantial direct contact with such surface of the support structure 6 wherein an edge portion of such bottom surface 42 distant from the second portion 30 may be slightly elevated above the surface of the support structure. Meanwhile first portion 22 is disposed generally horizontally within the edge slot or groove 2 so that one planar surface thereof, referenced with numeral 24, is disposed in substantially direct contact with one surface of the edge slot or groove 2, thus applying the required holding force or pressure onto the elongated covering member 2. It would be appreciated that the fastener 10 is applied in a similar manner, except for orientation of various portions when the support structure 6 and the elongated covering members are disposed vertically.

To facilitate application of the holding force or pressure there is means such as at least one prong 50 that is disposed on a free or distal edge 28 of the first portion 22. The at least one prong 50 is inclined in a direction toward the third portion 40 and preferably away from the second portion 30, the at least one prong 50 is at least partially penetrating into a thickness of a respective covering member 2 after the fastener 10 is fastened to the support structure. Preferably, the side edges of the at least one prong 50 taper toward each other terminating in a sharp point 52, as best shown in FIG. 8. Such at least one prong 50 has been also found advantageous in at least partially restraining the covering member 2 from movement in a longitudinal direction. When the third portion 40 is fastened to the joist 8, the point 52 engages in the inner side wall of the edge slot or groove 4 and holds the covering member 2 against displacement, especially displacement in a longitudinal direction. As best shown in FIG. 8, both corners of the edge 28 are being bent diagonally to direct to the point 52. However, the instant invention contemplates other means for facilitating application of the holding force or pressure, for example such as bent flanges, projections and the like features.

When the fastener 10 is affixed to the underlying support structure 6 by engaging a nail, screw or similar fastener F through the flexing part of the first arm 20, the third portion 40 is pulled down against the underlying structure 6. This in turn pulls the inserted first portion 22 toward the underlying structure, clamping the deck floor board snugly against the underlying structure by pressure applied by the first portion 22 of the first arm 20 against the lower side of the edge slot or groove 4.

To facilitate fastening of the body or arm 20, particularly with the use of power tools (not shown), there is an aperture 54 that is formed through the thickness of the body and arm 20 and, more particularly through the thickness of each second portion 30 and third portion 40 so as to position fasteners F at a conventional forty-five (45) degree angle.

The presently preferred material of the fastener 10 is stainless steel, although other materials, including plastics and combination of plastics with metals is also contemplated.

The instant invention also contemplates the use of the afore-described fastener 10 with any other suitable fasteners in a system wherein the fastener 10 would be employed for securing one edge of the elongated covering member 2, while the other fastener will be employed for at least securing an opposite facing edge of another elongated covering member 2.

Now in further reference to FIGS. 3-9, it is presently preferred configure the fastener 10 for securing the opposite facing edges of the pair of elongated covering members 2. This is achieved by providing another or second arm, generally designated as 60. Such second arm 60 has a first portion 62 thereof extending in a direction being opposite to the direction of the first portion 22 of now defined first arm 20. The first portion 62 has a pair of spaced apart planar surfaces 64, 66 defining thickness thereof. The first portion 62 of the second arm 60 is so sized that the first portion 62 of the second arm 60 is received within an edge slot or groove 4 of another elongated covering member 2.

The second arm 60 also has a second portion 70 that extends outwardly from the proximal edge of first portion 62 of the second arm 60. In the embodiment of FIG. 3, the second portion 70 upstands on the third portion 40 of the first arm 20, wherein the first portion 22, being the terminal portion, of the first arm 20 is disposed at a greater distance or elevation from the surface of the support structure 6 than the second portion 70, being the terminal portion, of the second arm 60 prior to fastening of the fastener 10 to the support structure. After such fastening, as the third portion 40 disposed substantially parallel to the surface of the support structure, the first portion 62 is disposed generally at the same distance from the surface of the support structure 6 so that the second portion 70 is positioned into the insertion into the edge slot or groove 4 of another elongated covering member 2. To facilitate fastening of the fastener 10 at the preferred angle of forty-five (45) degrees, the second portion 62 may be provided with an edge slot 68, while the second portion 70 may be provided with an aperture 78.

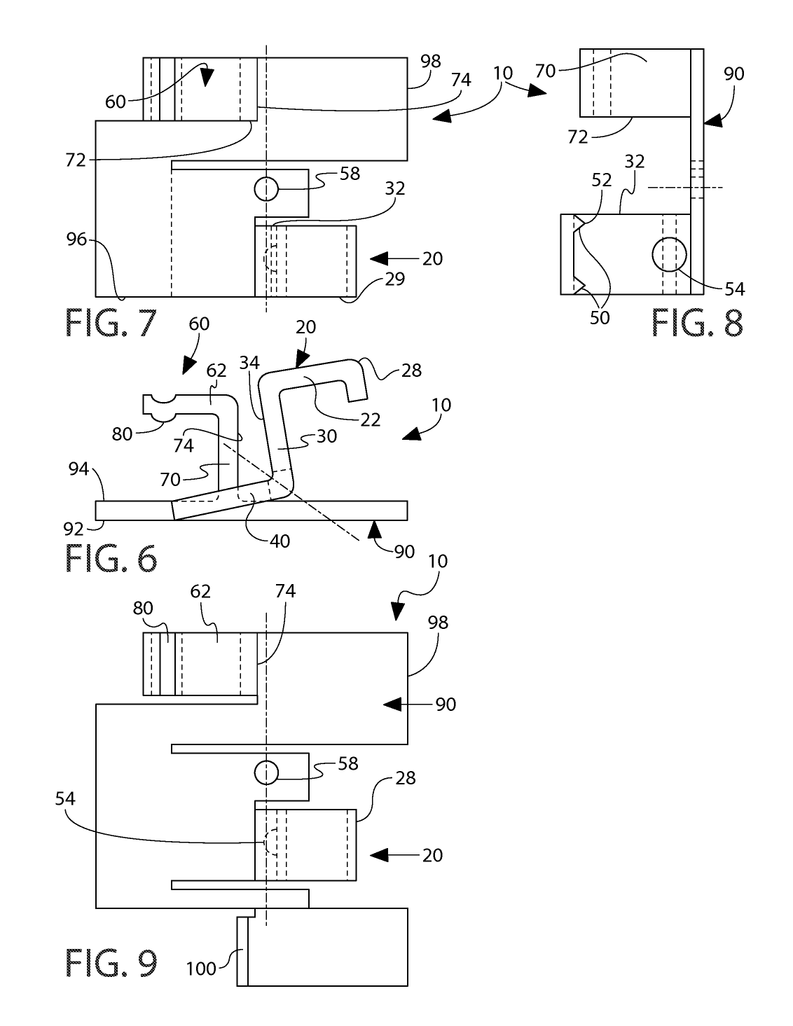

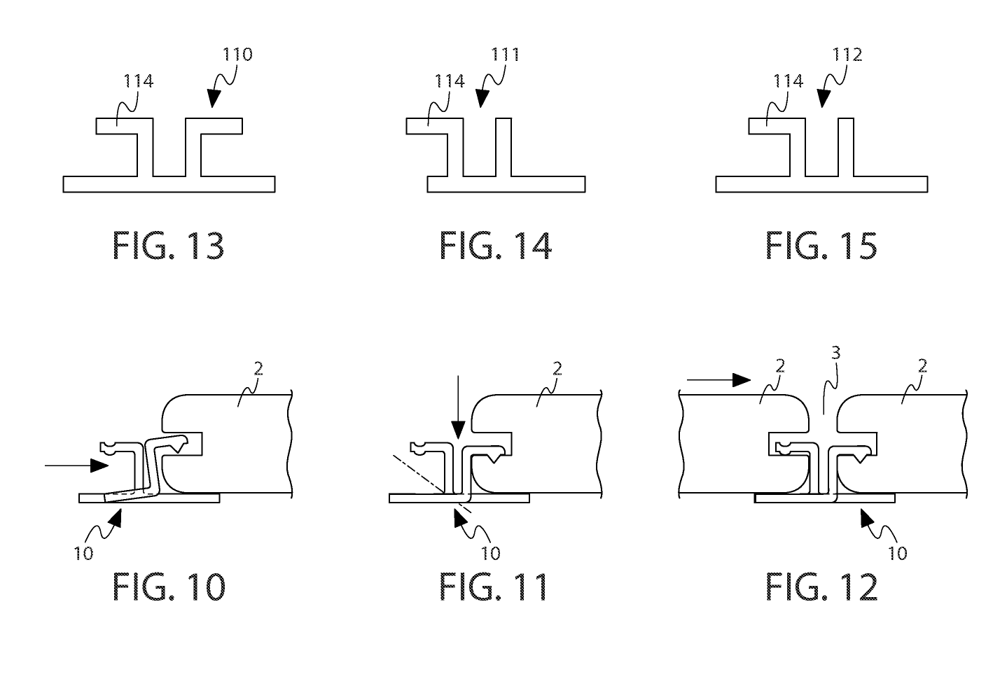

The second portion 70 is also adapted with means for applying a pressure onto at least one of the pair of elongated covering members 2 in a direction toward the support structure 6 that is shown, by way of one example only of FIG. 6, as a projection 80 disposed on a portion of the second arm 70, and having a uniform thickness throughout, although other features, such as flange and the like is also contemplated herein.

Thus, after the fasteners 10 are positioned in a spaced apart relationship with each other along one side of the covering member 2 and are fastened to the support structure 6, the adjacent covering member 2 is positioned in a juxtaposed relationship so that to insert all first portions 62 of the second arm 60 into its edge slot of groove 4.

In a further presently preferred embodiment, the fastener 10 is adapted with a base, generally designated as 90, that is preferably planar being defined by a pair of spaced apart planar surfaces 92 and 94 that, in turn, define a thickness of the base 90. The base 90 is shown as having a rectangular shape and having a width thereof being about equal to or smaller than a width of the joist 8 of the deck support structure. The base 90 is so disposed during use of the fastener 10, wherein one of the pair of spaced apart planar surfaces, referenced with numeral 92 is positioned in a direct abutting contact with a surface of the support structure. When the base 90 is provided, the third portion 40 of the first arm 20 is configured to depend from such base 90 providing essentially an advantageous “hinged effect” of the first arm 20 wherein the third portion 40 moves from a position being inclined relative to the surface of the support structure 6 into a position being disposed in a substantially direct contact with such surface of the such support structure 6 when the fastener 10 is fastened thereto. The base 90 is so sized that it extends under the surface of at least one and, preferably a pair of adjacent covering members 2 so as to cage a thickness portion thereof.

In a most presently preferred embodiment of the invention, the base 90 is so sized that the second arm 60 is spaced apart from the first arm 20. Accordingly, the second portion 70 is configured to depend from the base 90 being disposed substantially perpendicular thereto, wherein an inner edge 72 of the second portion of the second arm 60 is spaced from an inner edge 32 of the second portion 30 of the first arm 20 and wherein an inner surface 74 of the second portion 70 is spaced from and being substantially parallel to an inner surface 34 of the second portion 30 of the first arm 20. As previously described, the third and second portions, 40 and 30 respectively, position the first portion 20 at a greater distance from the surface of the support structure 6 than the distance of the second portion 70 of the second arm 60 prior to fastening of the fastener 10.

In the embodiment of FIG. 7, an outer side edge 29 of the first portion 20 being generally aligned with one outer edge 96 of the base 90, wherein the end edge 28 of the first portion 22 of the first arm 20 is positioned inwardly from an opposite transverse edge 98 of the base 90.

It is further presently preferred to set the width of the third portion 40 of the first arm 20 at least partially greater than the width of the second and first portions, 30 and 20 respectively, so as to provide another or second aperture 58 formed through a thickness of such third portion 40 and position such another or second aperture 58 in general alignment with the inner edge 32 of the second portion 30 of the first arm 20, so as to facilitate replacement of a damaged covering member 2. In order to replace the damaged covering member 2 it is first sawn through in a longitudinal direction and both halves are pried outwardly at the center away from the support structure 6 or a pulled out endwise. The fasteners 10 on one side of the damaged covering member 2 are removed and a new covering member 2 is put in place with one edge slot or groove 4 thereof engaging the first portions 22 of the remaining raw of fasteners 10. New fasteners 10 are then preferably forced to be slid longitudinally through the edge slot or groove 4 and are aligned with each joist 8. The second aperture 58, which is advantageously positioned in a mandated gap between the pair of covering member 2 and is therefore being readily accessible through the required air gap 3 between a pair of elongated covering members 2 is then used to fasten the fasteners 10 with conventional fasteners F through the “hinged” third portion 40.

In another form, the fastener 10 may be also provided with a flange 100 upstanding on the base 90 and being positioned in a plane defined by the second portion 70 of the second arm 60 so as to enhance positioning of the opposite covering member 2. The flange 100 may be further provided with a portion (not shown) sized to engage the edge slot or groove 4.

It is presently preferred to provide fastener 10 as a unitary one-piece fastener 10. The shape of the fastener 10 and its arms 20 and 60 can be simply formed as part of a stamping process in which the fastener 10 is formed from sheet stock. In the case of a resilient material such as spring steel or stainless, the stamping process can be arranged to form a bend in the arm 20 of the hinged flange. Heat treatments and anticorrosion coatings are advantageous and are contemplated in the instant invention.

Thus, the instant invention is advantageous for providing a decking system that includes a deck support structure 6 defined by a plurality of joists 8 disposed in a spaced apart relationship with each other; a plurality of elongated deck covering members 2 supported on the plurality of joists 8, the plurality of deck covering members 2 disposed in a juxtaposed relationship with each other and separated from each other by an air gap; and a plurality of fasteners 10 for securing the plurality of elongated deck covering members 2 together and to the deck support structure 6, at least a portion of the plurality of fasteners including an arm 20 having a first portion 22 sized so as to be received within an edge slot or grove 4 of a respective elongated deck covering member 2, a second portion 30 disposed substantially perpendicular to the first portion 22 and a third portion 40 extending from the second portion 30 and disposed at an acute angle relative to the support structure 6 prior to use of the at least a portion of the plurality of fasteners 10.

The decking system further includes a second portion of the plurality of the fasteners 110, 111 or 112, interposed with the first portion of the plurality of the fasteners 10 between each pair of the elongated deck covering members 2, each of the second portion of the plurality of the fasteners includes a planar base and at least one L-shaped arm 114 having one leg thereof being sized so as to be received within an edge slot or groove of another respective elongated deck covering member, the one leg 114 extending in a direction being opposite to a direction of the first portion 22 of the arm 20.

Preferably, the at least a portion of the plurality of fasteners 10 is entire plurality of the fasteners 10, wherein each fastener 10 also includes a second arm 60 having a first portion 62 thereof extending in a direction being opposite to a direction of the first portion 22 of the first arm 20.

It must be noted that in order to achieve the “hinge” effect of the third portion 40, the force of the flexing can be modest so that the fastener 10 does not exert a force sufficient to back out a fastener F or raise the edge of the covering member 2.

Although deck lumber is sometimes cumbersome and may not be wholly straight, the disclosed fastener 10 provides a convenient hidden deck fastener that installs quickly and effectively and serves to pull any bow in the planks down against the joists 8 while also aligning the operative upper surface of the adjacent covering members 2 to provide a flat deck. The fastener 10 securely and conveniently installs closely spaced decking covering member 2 to joists 8 essentially leaving no visible fasteners 10.

Although the present invention has been shown in terms of the decking system, it will be apparent to those skilled in the art, that the present invention may be applied to other systems employing elongated covering members with side edge slots or grooves and being fastened to a support structure or substrate.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A fastener for fastening at least a pair of elongated members to a support structure, said fastener comprising:
(a) a first arm having a first portion sized to be received within an edge groove or a slot of one elongated member, a second portion disposed substantially perpendicular to said first portion and a third portion disposed at an acute angle to a surface of the support structure prior to use of said fastener, wherein said first portion extends in a first direction from said second portion; and
(b) a second arm having a portion thereof extending in a second direction being opposite to said first direction, said portion of said second arm is sized to be received within an edge groove or a slot of another elongated member juxtaposed with the one elongated member.

2. The fastener of claim 1, wherein said second arm has another portion thereof upstanding on said third portion of said first arm.

3. The fastener of claim 1, wherein said first portion of said first arm is disposed at a higher distance than said portion of said second arm prior to use of said fastener.

4. The fastener of claim 1, further including means for applying a pressure onto at least one of the pair of elongated members in a direction toward the support structure.

5. The fastener of claim 3, wherein said pressure applying means includes a projection disposed on said portion of said second arm received within said edge groove or slot of said another elongated member.

6. The fastener of claim 1, further including at least one prong disposed on a free edge of said first portion of said first arm, said at least one prong inclined in a direction toward said base, said at least one prong at least partially penetrating into a thickness of a respective elongated member after said fastener is fastened to the support structure.

7. The fastener of claim 1, further including at least one aperture formed through a thickness of said first arm.

8. The fastener of claim 1, wherein said fastener includes a base, wherein said third portion of said first arm depends from said base and wherein said second arm has another portion upstanding substantially perpendicular on said base, wherein an inner edge of said another portion of said second arm is spaced from an inner edge of said second portion of said first arm and wherein an inner surface of said second arm is spaced from and being substantially parallel to an inner surface of said first arm.

9. The fastener of claim 8, further including a pair of apertures, one of said pair of apertures formed through a thickness of each of said second and third portions of said first arm, other one of said pair of apertures is formed through a thickness of said third portion and is generally aligned with said inner edge of said second portion of said first arm.

10. The fastener of claim 1, further including a flange upstanding on said base external to said first arm, said flange disposed in a plane defined by a vertical portion of said second arm when said fastener is fastened to the support structure.

11. A unitary one-piece resilient fastener for fastening elongated deck members to a deck support structure, said fastener comprising:
(a) a base having a rectangular shape and a pair of spaced apart planar surfaces defining thickness of said base, said base having a width thereof being about equal to or smaller than a width of a member of the deck support structure, wherein one of said pair of spaced apart planar surfaces is positioned in a substantial direct abutting contact with a surface of the deck support structure;
(b) a first arm including:
i. a first portion disposed at an acute angle to said base prior to use of said fastener and disposed generally parallel to said base when said fastener is fastened to the deck support structure, said first portion having a pair of spaced apart planar surfaces defining thickness of said first portion, said first portion is so sized that said first portion is received within an edge groove or slot of one elongated deck member, said first portion extending in a first direction, said first portion having an outer side edge thereof being generally aligned with one outer edge of said base, wherein an end edge of said first portion of said first arm is positioned inwardly from an opposite transverse edge of said base,
ii. at least one prong disposed on a free edge of said first portion of said first arm, said at least one prong inclined in a direction toward said base, said at least one prong at least partially penetrating into a thickness of the elongated deck member,
iii. a second portion disposed generally perpendicular to said first portion,
iv. a third portion connecting said second portion to said base and disposed at an acute angle thereto prior to use of said fastener, said third portion being wider than each of said first and second portions, said third portion having an inner edge thereof disposed parallel to an inner edge of said base and is spaced a predetermined distance therefrom, said third portion disposed for movement in a generally vertical direction relative to said base,
v. said first arm defining a generally Z-shape cross-section thereof, and
vi. said second and third portions supporting said first portion of said first arm at a first distance from the surface of the deck support structure prior to said use of said fastener;
(c) a second arm depending from said base, said second arm including:
i. a first portion disposed generally parallel to said base, said first portion of said second arm having a pair of spaced apart planar surfaces defining thickness thereof, said first portion of said second arm is so sized that said first portion of said second arm is received within an edge groove or slot of another one elongated deck member, said first portion of said second arm having an outer side edge thereof being generally aligned with an opposite outer edge of said base, wherein an end edge of said first portion of said second arm is positioned inwardly from another transverse edge of said base, and wherein said first portion of said second arm is disposed at a second distance from the surface of the deck support structure, said second distance being smaller than said first distance of said first portion of said first arm from the surface of the deck support structure,
ii. a second portion extending from an opposite planar surface of said base and supporting said first portion of said second arm at said second distance from the surface of the deck support structure, said second portion of said second arm disposed generally perpendicular to each of said base and said first portion of said second arm so as to define a generally L-shape cross-section of said second arm, an inner edge of said second portion of said second arm is spaced apart from an inner edge of said first portion of said first arm, and
iii. a projection provided on one surface of said first portion of said second arm in direct engagement with one surface of the edge groove or slot of the one elongated deck member;
(d) a first aperture formed through a thickness of said second and third portions of said first arm; and
(e) a second aperture formed through said thickness of said third portion of said first arm between said inner edge of said second portion of said first arm and said inner edge of said second portion of said second arm, said second aperture generally aligned with gap between opposing side edges of a pair of adjacent elongated deck members.

12. A method of fastening deck covering members to a deck support structure, said method comprising the steps of:
(a) providing at least one fastener defining a first arm configured for movement in a generally vertical direction relative to a surface of said deck support structure and a second arm disposed in a spaced apart relationship with said first arm;
(b) positioning a portion of said first arm an angle relative to said surface of said deck support structure;
(c) inserting a flange of said first arm into an edge groove or slot of one deck covering member;
(d) fastening said first arm to said deck support structure; and
(e) inserting a flange of said second arm into an edge groove or slot of an adjacently juxtaposed deck covering member.

13. The method of claim 12, further including an additional step of applying pressure onto at least said adjacent deck member in a direction toward said deck support structure.

14. The method of claim 12, further including an additional step of caging an edge thickness portion of each deck member between a base surface and a surface of at least one of said first and second arms.

15. The method of claim 12, further including the step of providing said at least one fastener as a plurality of fasteners and the step of positioning said plurality of fasteners in a spaced apart relationship with each other along side edges of said deck covering members.

16. A decking system comprising:
(a) a deck support structure 6 defined by a plurality of joists disposed in a spaced apart relationship with each other;
(b) a plurality of elongated deck covering members supported on said plurality of joists, said plurality of deck covering members disposed in a juxtaposed relationship with each other and separated from each other by an air gap; and
(c) a plurality of fasteners for securing the plurality of elongated deck covering members together and to said deck support structure, at least a portion of said plurality of fasteners including an arm having a first portion sized so as to be received within an edge groove or a slot of a respective elongated deck covering member, a second portion disposed substantially perpendicular to said first portion and a third portion extending from said base at an acute angle thereto prior to use of said at least a portion of said plurality of fasteners.

17. The decking system of claim 16, wherein said at least a portion of said plurality of fasteners is entire plurality of said fasteners and wherein each fastener also includes a second arm having a portion thereof extending in a direction being opposite to a direction of said first portion of said first arm.

18. The decking system of claim 16, wherein said at least a portion of said plurality of fasteners is a first portion of said plurality of said fasteners and wherein said decking system includes a second portion of said plurality of said fasteners interposed with said first portion of said plurality of said fasteners between each pair of said elongated deck covering members, each of said second portion of said plurality of said fasteners includes a planar base and an L-shaped arm having one leg thereof being sized so as to be received within an edge groove or a slot of another respective elongated deck covering member, said one leg extending in a direction being opposite to a direction of said first portion of said arm.
